(19) United States
(12) Patent Application Publication
(10) Pub. No.: US 2026/0302356 A1
(43) Pub. Date: Oct. 1, 2026

(54) Electrolytes Comprising Steric Ethers for Lithium-Metal Batteries

(71) Applicant: Feon Energy, Inc., Woburn, MA (US)

(72) Inventors: Kuan Cheng, Woburn, MA (US); Harman Kessinger, Woburn, MA (US); Zhiao Yu, Woburn, MA (US); Wenxiao Huang, Woburn, MA (US)

(21) Appl. No.: 19/565,924

(22) Filed: Mar. 13, 2026

Related U.S. Application Data
(60) Provisional application No. 63/774,208, filed on Mar. 19, 2025.

(51) Int. Cl. H01M 10/0569; H01M 10/052; H01M 10/0567; H01M 10/0568

(52) U.S. Cl. CPC H01M 10/0569; H01M 10/052; H01M 10/0567; H01M 10/0568; H01M 2300/0034; H01M 2300/0037

(57) ABSTRACT

Described herein are liquid electrolytes for lithium-metal batteries, as well as lithium-metal batteries comprising such electrolytes in addition to lithium-metal negative electrodes and positive electrodes. In some examples, a liquid electrolyte comprises one or more lithium-containing salts in the liquid electrolyte, one or more steric-ether solvents, one or more tertiary partially fluorinated ethers, and (optionally) one or more electrolyte additives. Some examples of steric-ether solvents include 1,2-dimethoxy propane (DMIP), methyl (3-methoxypropyl) ether (MMPE), 2,2-difluoro-1,3-diethoxy propane (FDEPr), 1,2-diethoxyethane (DEE), 1-methoxy 2-ethoxy ethane (MEE), 2-(2-(2,2-difluoroethoxy)ethoxy)-ethane (F2EE), 1-propoxy 2-methoxy ethane (PME), 1-isopropoxy 2-methoxy ethane (IPME), 2-(2,2-difluoroethoxy)ethoxy methane (F2ME), 1-propoxy 2-ethoxy ethane (PEE), 1-isopropoxy 2-ethoxy ethane (IPEE), and 2-(2,2,2-trifluoroethoxy)ethoxy methane (F3ME). 2-(2-(2,2-difluoroethoxy)ethoxy)-1,1,1-trifluoroethane (F5) may be used as a tertiary partially fluorinated ether, while 1,1,2,2-tetrafluoroethyl 2,2,3,3-tetrafluoropropylether (TTE) may be used as a diluent.

### CROSS-REFERENCE TO RELATED APPLICATIONS

This application claims the benefit under 35 U.S.C. § 119(e) of U.S. Provisional Patent Application 63/774,208, filed on 2025 Mar. 19, which is incorporated herein by reference in its entirety for all purposes.

### BACKGROUND

Lithium-ion (Li-ion) batteries are extensively used across various applications. They power devices ranging from small medical instruments and cell phones to large-scale applications like electric vehicles and aircraft. The widespread adoption of Li-ion batteries across multiple industries has led to significant advancements in their design and manufacturing. Notably, concerns related to cycling efficiency, capacity, and safety have been extensively addressed.

Lithium metal (Li-metal) batteries, on the other hand, represent a distinct battery technology separate from Li-ion cells. Unlike Li-ion batteries, which use specialized negative-electrode active materials (e.g., graphite, silicon) to capture lithium ions during charging, Li-metal batteries rely on the direct deposition (e.g., plating) of lithium metal onto the negative current collectors, eliminating the need for additional active materials. As a result, Li-metal batteries are lighter and offer a higher energy density than Li-ion batteries.

Despite these advantages, Li-metal batteries have not yet achieved widespread adoption on the same scale as Li-ion batteries. One challenge involves various electrolyte/electrode interactions and lithium dendrite formation.

### SUMMARY

Described herein are liquid electrolytes for lithium-metal batteries, as well as lithium-metal batteries comprising such electrolytes in addition to lithium-metal negative electrodes and positive electrodes. In some examples, a liquid electrolyte comprises a lithium-containing salt, one or more steric-ether solvents, one or more diluents, one or more tertiary partially fluorinated diethers, and (optionally) one or more electrolyte additives. Some examples of steric-ether solvents include 1,2-dimethoxy propane (DMIP), methyl (3-methoxypropyl) ether (MMPE), 2,2-difluoro-1,3-diethoxy propane (FDEPr), 1,2-diethoxyethane (DEE), 1-methoxy 2-ethoxy ethane (MEE), 2-(2-(2,2-difluoroethoxy)ethoxy)-ethane (F2EE), 1-propoxy 2-methoxy ethane (PME), 1-isopropoxy 2-methoxy ethane (IPME), 2-(2,2-difluoroethoxy)ethoxy methane (F2ME), 1-propoxy 2-ethoxy ethane (PEE), 1-isopropoxy 2-ethoxy ethane (IPEE), 2-(2,2,2-trifluoroethoxy)ethoxy methane (F3ME), and mixtures of any of the foregoing. Some examples of diluents include bis(2,2,2-trifluoroethyl) ether (BTFE), 1,1,2,2-tetrafluoroethyl-2,2,3,3-tetrafluoropropyl ether (TTE), 1H,1H,5H-octafluoropentyl-1,1,2,2-tetrafluoroethylether (OTE), 2,2,2-trifluoroethyl 1,1,2,2-tetrafluoroethyl ether (HFE), tris(2,2,2-trifluoroethyl) orthoformate (TFEO) and 1,2-bis(1,1,2,2-tetrafluoroethoxy)ethane (F8), 1,3-(1,1,2,2-Tetrafluoroethoxy)propane (F8P), fluorobenzene, 1,2-difluorobenzene, benzotrifluoride, (trifluoromethoxy)benzene, dichloromethane, toluene, and mixtures of any of the foregoing. Some examples of tertiary partially fluorinated ethers include 1-ethoxy-2-(2-fluoroethoxy)ethane (F1), 2-(2-ethoxyethoxy)-1,1-difluoroethane (F2), 1,2-bis(2-fluoroethoxy)ethane (F1F1), 1,1-difluoro-2-(2-(2-fluoroethoxy)ethoxy)ethane (F1F2), 1,1,1-trifluoro-2-(2-(2-fluoroethoxy)ethoxy)ethane (F1F3), 2-(2-ethoxyethoxy)-1,1,1-trifluoroethane (F3), 1,2-bis(2,2-difluoroethoxy)ethane (F4), 2-(2-(2,2-difluoroethoxy)ethoxy)-1,1,1-trifluoroethane (F5) and 1,2-bis(2,2,2-trifluoroethoxy)ethane (F6), and mixtures of any of the foregoing. Some examples of electrolyte additives include ethylene carbonate (EC), propylene carbonate (PC), dimethyl carbonate (DMC), diethyl carbonate (DEC), ethyl methyl carbonate (EMC), vinyl carbonate (VC), vinyl ethylene carbonate (VEC), fluoroethylene carbonate (FEC), difluoroethylene carbonate (DFEC), 3,3,3-trifluoropropylene carbonate (TFPC), 1,2-dimethyoxylethane (DME), 1,3-dioxolane (DOL), 1,4-dioxane (DOX), tetrahydrofuran (THF), acetonitrile (AN), ethyl acetate (EA), methyl acetate (MA), methyl propanoate (MP), ethyl propanoate (EP), propyl propanoate (PP), N,N-Dimethylformamide (DMF), gamma-butyrolactone (BL), succinic anhydride (SA), butyric anhydride (BA), tetravinyl silane (TVSI), succinonitrile (SN), adiponitrile (ADN), 1,3,6-Hexanetricarbonitrile (HTCN), trimethyl borate (TMB), triphenyl borate (TPB), triethyl borate (TEB), tris(pentafluorophenyl)borane (TPFPB), tris(trimethylsilyl)phosphate (TTSB), tris(2,2,2-trifluoroethyl) borate (TTFEB), trimethyl phosphate (TMP), triethyl phosphate (TEP), tris(trimethylsilyl)phosphate (TTSP), tris(trimethylsilyl)phosphite (TTSPi), tris(2,2,2-trifluoroethyl) phosphate (TFEPa), tris(2,2,2-trifluoroethyl) phosphite (TFEPi), (pentafluorophenyl)diphenyl phosphine (PFPDPP), tris(pentafluorophenyl) phosphine (TPFPP), ethoxy(pentafluoro)cyclotriphosphazene (PFPN), 1,3,2-dioxathiolane-2,2-dioxide (DTD), 1,3-propanesultone (PS), prop-1-ene-1,3-sultone (PES), propanediol cyclic sulfate (PCS), ethylene sulfite (ES), 1,4-butane sultone (BS), diphenyl sulfone (DPS), dimethyl sulfoxide (DMSO), 1,2,6-oxadithiane-2,2,6,6-tetraoxide (ODTO), methylene methanedisulfonate (MMDS), lithium bis(trifluoromethanesulfonyl)imide (LiTFSI), lithium bis(pentafluoroethanesulfonyl)imide (LiBETI), lithium hexafluorophosphate (LiPF6), lithium hexafluoroarsenate (LiAsF6), lithium tetrafluoroborate (LiBF4), lithium bis(oxalato)borate (LiBOB), lithium difluoro(oxalato)borate (LiDFOB), lithium difluorophosphate (LiDFP), lithium difluoro(dioxalato)phosphate (LiDFDOP), lithium tetrafluoro(oxalato)phosphate (LiTFOP), lithium nitrate (LiNO3), lithium perchlorate (LiClO4), lithium triflate (LiTf), lithium trifluoroacetate (LiTFA), lithium 4,5-dicyano-2-(trifluoromethyl)imidazole (LiTDI), sodium hexafluorophosphate (NaPF6), sodium bis(fluorosulfonyl)imide (NaFSI), sodium bis(trifluoromethanesulfonyl)imide (NaTFSI), sodium triflate (NaTf), sodium bis(pentafluoroethanesulfonyl)imide (NaBETI), potassium hexafluorophosphate (KPF6), potassium bis(fluorosulfonyl)imide (KFSI), potassium bis(trifluoromethanesulfonyl)imide (KTFSI), potassium triflate (KTf), cesium bis(fluorosulfonyl)imide (CsFSI), cesium bis(trifluoromethanesulfonyl)imide (CsTFSI), magnesium bis(trifluoromethanesulfonyl)imide (Mg(TFSI)2), zinc bis(trifluoromethanesulfonyl)imide (Zn(TFSI)2), calcium bis(trifluoromethanesulfonyl)imide (Ca(TFSI)2), silver bis(trifluoromethanesulfonyl)imide (AgTFSI), aluminum bis(trifluoromethanesulfonyl)imide (AI(TFSI)3), lanthanum bis(trifluoromethanesulfonyl)imide (La(TFSI)3), and mixtures of any of the foregoing.

Clause 1. A liquid electrolyte for a lithium-metal battery, the liquid electrolyte comprising: a lithium-containing salt having a concentration of at least 1.5M in the liquid electrolyte; a steric-ether solvent selected from the group consisting of 1,2-dimethoxy propane (DMIP), methyl (3-methoxypropyl) ether (MMPE), 2,2-difluoro-1,3-diethoxy propane (FDEPr), 1,2-diethoxyethane (DEE), 1-methoxy 2-ethoxy ethane (MEE), 2-(2-(2,2-difluoroethoxy)ethoxy)-ethane (F2EE), 1-propoxy 2-methoxy ethane (PME), 1-isopropoxy 2-methoxy ethane (IPME), 2-(2,2-difluoroethoxy)ethoxy methane (F2ME), 1-propoxy 2-ethoxy ethane (PEE), 1-isopropoxy 2-ethoxy ethane (IPEE), and 2-(2,2,2-trifluoroethoxy)ethoxy methane (F3ME); and a diluent.

Clause 2. The liquid electrolyte of clause 1, wherein the diluent comprises one or more materials selected from the group consisting of bis(2,2,2-trifluoroethyl) ether (BTFE), 1,1,2,2-tetrafluoroethyl-2,2,3,3-tetrafluoropropyl ether (TTE), 1H,1H,5H-octafluoropentyl-1,1,2,2-tetrafluoroethylether (OTE), 2,2,2-trifluoroethyl 1,1,2,2-tetrafluoroethyl ether (HFE), tris(2,2,2-trifluoroethyl) orthoformate (TFEO) and 1,2-bis(1,1,2,2-tetrafluoroethoxy)ethane (F8), 1,3-(1,1,2,2-Tetrafluoroethoxy)propane (F8P), fluorobenzene, 1,2-difluorobenzene, benzotrifluoride, (trifluoromethoxy)benzene, dichloromethane, toluene, and mixtures of any of the foregoing. In some examples, the diluent is bis(2,2,2-trifluoroethyl) ether (BTFE), 1,1,2,2-tetrafluoroethyl-2,2,3,3-tetrafluoropropyl ether (TTE), 1,2-bis(1,1,2,2-tetrafluoroethoxy)ethane (F8), 1,3-(1,1,2,2-Tetrafluoroethoxy)propane (F8P), fluorobenzene, benzotrifluoride, (trifluoromethoxy)benzene, and toluene.

Clause 3. The liquid electrolyte of clause 1, wherein the diluent comprises one or more materials selected from the group consisting of bis(2,2,2-trifluoroethyl) ether (BTFE), 1,1,2,2-tetrafluoroethyl-2,2,3,3-tetrafluoropropyl ether (TTE), 1H,1H,5H-octafluoropentyl-1,1,2,2-tetrafluoroethylether (OTE), 2,2,2-trifluoroethyl 1,1,2,2-tetrafluoroethyl ether (HFE), tris(2,2,2-trifluoroethyl) orthoformate (TFEO), 1,2-bis(1,1,2,2-tetrafluoroethoxy)ethane (F8), 1,3-(1,1,2,2-Tetrafluoroethoxy)propane (F8P), fluorobenzene, 1,2-difluorobenzene, benzotrifluoride, (trifluoromethoxy)benzene, dichloromethane, and toluene.

Clause 4. The liquid electrolyte of clause 1, wherein the diluent comprises one or more materials selected from the group consisting of bis(2,2,2-trifluoroethyl) ether (BTFE), 1,1,2,2-tetrafluoroethyl-2,2,3,3-tetrafluoropropyl ether (TTE), 1,2-bis(1,1,2,2-tetrafluoroethoxy)ethane (F8), 1,3-(1,1,2,2-Tetrafluoroethoxy)propane (F8P), fluorobenzene, benzotrifluoride, (trifluoromethoxy)benzene, and toluene.

Clause 5. The liquid electrolyte of clause 1, wherein the diluent is 1,1,2,2-tetrafluoroethyl 2,2,3,3-tetrafluoropropylether (TTE).

Clause 6. The liquid electrolyte of clause 1, wherein the lithium-containing salt has a concentration of at least 2M.

Clause 7. The liquid electrolyte of clause 1, wherein the lithium-containing salt has a concentration of at least 2.5M.

Clause 8. The liquid electrolyte of clause 1, wherein the lithium-containing salt has a concentration of at least 3M.

Clause 9. The liquid electrolyte of clause 1, wherein the lithium-containing salt has a concentration of at least 3.5M.

Clause 10. The liquid electrolyte of clause 1, wherein the lithium-containing salt has a concentration of 2-3M.

Clause 11. The liquid electrolyte of clause 1, wherein the lithium-containing salt is selected from the group consisting of lithium bis(fluorosulfonyl)imide (LiFSI), lithium bis(trifluoromethanesulfonyl)imide (LiTFSI), lithium hexafluorophosphate (LiPF6), lithium difluoro(oxalato)borate (LiDFOB), and lithium difluorophosphate.

Clause 12. The liquid electrolyte of clause 1, wherein the lithium-containing salt is lithium bis(fluorosulfonyl)imide (LiFSI).

Clause 13. The liquid electrolyte of clause 1, wherein the steric-ether solvent is 1,2-dimethoxy propane (DMIP).

Clause 14. The liquid electrolyte of clause 1, wherein the steric-ether solvent is methyl (3-methoxypropyl) ether (MMPE).

Clause 15. The liquid electrolyte of clause 1, wherein the steric-ether solvent is 2,2-difluoro-1,3-diethoxy propane (FDEPr).

Clause 16. The liquid electrolyte of clause 1, wherein the steric-ether solvent is 1-methoxy 2-ethoxy ethane (MEE).

Clause 17. The liquid electrolyte of clause 1, wherein the steric-ether solvent is 2-(2-(2,2-difluoroethoxy)ethoxy)-ethane (F2EE).

Clause 18. The liquid electrolyte of clause 1, wherein the steric-ether solvent is 1-propoxy 2-methoxy ethane (PME).

Clause 19. The liquid electrolyte of clause 1, wherein the steric-ether solvent is 1-isopropoxy 2-methoxy ethane (IPME).

Clause 20. The liquid electrolyte of clause 1, wherein the steric-ether solvent is 2-(2,2-difluoroethoxy)ethoxy methane (F2ME).

Clause 21. The liquid electrolyte of clause 1, wherein the steric-ether solvent is 1-propoxy 2-ethoxy ethane (PEE).

Clause 22. The liquid electrolyte of clause 1, wherein the steric-ether solvent is 2-(2,2,2-trifluoroethoxy)ethoxy methane (F3ME).

Clause 23. The liquid electrolyte of clause 1, wherein the steric-ether solvent is 1-isopropoxy 2-ethoxy ethane (IPEE).

Clause 24. The liquid electrolyte of clause 23, wherein the diluent is 1,1,2,2-tetrafluoroethyl 2,2,3,3-tetrafluoropropylether (TTE).

Clause 25. The liquid electrolyte of clause 24, wherein a volumetric ratio of the steric-ether solvent to the diluent is between 1:3 and 1:1.

Clause 26. The liquid electrolyte of clause 23, wherein the liquid electrolyte consists essentially of: lithium bis(fluorosulfonyl)imide (LiFSI) operable as the lithium-containing salt, 1-isopropoxy 2-ethoxy ethane (IPEE) operable as the steric-ether solvent, and 1,1,2,2-tetrafluoroethyl 2,2,3,3-tetrafluoropropylether (TTE) operable as the diluent.

Clause 27. The liquid electrolyte of clause 1, further comprising a tertiary partially fluorinated ether.

Clause 28. The liquid electrolyte of clause 27, wherein the tertiary partially fluorinated ether is selected from the group consisting of 1-ethoxy-2-(2-fluoroethoxy)ethane (F1); 2-(2-ethoxyethoxy)-1,1-difluoroethane (F2); 1,2-bis(2-fluoroethoxy)ethane (F1F1); 1,1-difluoro-2-(2-(2-fluoroethoxy)ethoxy)ethane (F1F2); 1,1,1-trifluoro-2-(2-(2-fluoroethoxy)ethoxy)ethane (F1F3); 2-(2-ethoxyethoxy)-1,1,1-trifluoroethane (F3); 1,2-bis(2,2-difluoroethoxy)ethane (F4); 2-(2-(2,2-difluoroethoxy)ethoxy)-1,1,1-trifluoroethane (F5), and 1,2-bis(2,2,2-trifluoroethoxy)ethane (F6).

Clause 29. The liquid electrolyte of clause 27, wherein the tertiary partially fluorinated ether is 1,2-bis(2,2-difluoroethoxy)ethane (F4) or 2-(2-(2,2-difluoroethoxy)ethoxy)-1,1,1-trifluoroethane (F5).

Clause 30. The liquid electrolyte of clause 27, wherein the steric-ether solvent is 1,2-diethoxyethane (DEE).

Clause 31. The liquid electrolyte of clause 30, wherein a volumetric ratio of the steric-ether solvent to the diluent is between 1:3 and 1:1.

Clause 32. The liquid electrolyte of clause 30, wherein a volumetric ratio of the steric-ether solvent to the tertiary partially fluorinated ether is between 1:2 and 2:1.

Clause 33. The liquid electrolyte of clause 27, wherein the liquid electrolyte consists essentially of: lithium bis(fluorosulfonyl)imide (LiFSI) operable as the lithium-containing salt, 1,2-diethoxyethane (DEE) operable as the steric-ether solvent, and 1,1,2,2-tetrafluoroethyl 2,2,3,3-tetrafluoropropylether (TTE) operable as the diluent, and 1,2-diethoxyethane (DEE) operable as the steric-ether solvent.

Clause 34. The liquid electrolyte of clause 1, wherein the liquid electrolyte further comprises an additive selected from the group consisting of ethylene carbonate (EC), propylene carbonate (PC), dimethyl carbonate (DMC), diethyl carbonate (DEC), ethyl methyl carbonate (EMC), vinyl carbonate (VC), vinyl ethylene carbonate (VEC), fluoroethylene carbonate (FEC), difluoroethylene carbonate (DFEC), 3,3,3-trifluoropropylene carbonate (TFPC), 1,2-dimethyoxylethane (DME), 1,3-dioxolane (DOL), 1,4-dioxane (DOX), tetrahydrofuran (THF), acetonitrile (AN), ethyl acetate (EA), methyl acetate (MA), methyl propanoate (MP), ethyl propanoate (EP), propyl propanoate (PP), N,N-Dimethylformamide (DMF), gamma-butyrolactone (BL), succinic anhydride (SA), butyric anhydride (BA), tetravinyl silane (TVSI), succinonitrile (SN), adiponitrile (ADN), 1,3,6-Hexanetricarbonitrile (HTCN), trimethyl borate (TMB), triphenyl borate (TPB), triethyl borate (TEB), tris(pentafluorophenyl)borane (TPFPB), tris(trimethylsilyl)phosphate (TTSB), tris(2,2,2-trifluoroethyl) borate (TTFEB), trimethyl phosphate (TMP), triethyl phosphate (TEP), tris(trimethylsilyl)phosphate (TTSP), tris(trimethylsilyl)phosphite (TTSPi), tris(2,2,2-trifluoroethyl) phosphate (TFEPa), tris(2,2,2-trifluoroethyl) phosphite (TFEPi), (pentafluorophenyl)diphenyl phosphine (PFPDPP), tris(pentafluorophenyl) phosphine (TPFPP), ethoxy(pentafluoro)cyclotriphosphazene (PFPN), 1,3,2-dioxathiolane-2,2-dioxide (DTD), 1,3-propanesultone (PS), prop-1-ene-1,3-sultone (PES), propanediol cyclic sulfate (PCS), ethylene sulfite (ES), 1,4-butane sultone (BS), diphenyl sulfone (DPS), dimethyl sulfoxide (DMSO), 1,2,6-oxadithiane-2,2,6,6-tetraoxide (ODTO), methylene methanedisulfonate (MMDS), lithium bis(trifluoromethanesulfonyl)imide (LiTFSI), lithium bis(pentafluoroethanesulfonyl)imide (LiBETI), lithium hexafluorophosphate (LiPF6), lithium hexafluoroarsenate (LiAsF6), lithium tetrafluoroborate (LiBF4), lithium bis(oxalato)borate (LiBOB), lithium difluoro(oxalato)borate (LiDFOB), lithium difluorophosphate (LiDFP), lithium difluoro(dioxalato)phosphate (LiDFDOP), lithium tetrafluoro(oxalato)phosphate (LiTFOP), lithium nitrate (LiNO3), lithium perchlorate (LiClO4), lithium triflate (LiTf), lithium trifluoroacetate (LiTFA), lithium 4,5-dicyano-2-(trifluoromethyl)imidazole (LiTDI), sodium hexafluorophosphate (NaPF6), sodium bis(fluorosulfonyl)imide (NaFSI), sodium bis(trifluoromethanesulfonyl)imide (NaTFSI), sodium triflate (NaTf), sodium bis(pentafluoroethanesulfonyl)imide (NaBETI), potassium hexafluorophosphate (KPF6), potassium bis(fluorosulfonyl)imide (KFSI), potassium bis(trifluoromethanesulfonyl)imide (KTFSI), potassium triflate (KTf), cesium bis(fluorosulfonyl)imide (CsFSI), cesium bis(trifluoromethanesulfonyl)imide (CsTFSI), magnesium bis(trifluoromethanesulfonyl)imide (Mg(TFSI)2), zinc bis(trifluoromethanesulfonyl)imide (Zn(TFSI)2), calcium bis(trifluoromethanesulfonyl)imide (Ca(TFSI)2), silver bis(trifluoromethanesulfonyl)imide (AgTFSI), aluminum bis(trifluoromethanesulfonyl)imide (AI(TFSI)3), and lanthanum bis(trifluoromethanesulfonyl)imide (La(TFSI)3).

Clause 35. The liquid electrolyte of clause 34, wherein the additive is selected from the group consisting of diphenyl sulfone (DPS), lithium difluoro(oxalato)borate (DFOB), lithium difluorophosphate (DFP), lithium bis(oxalato)borate (BOB), and lithium tetrafluoroborate (BF4).

Clause 36. The liquid electrolyte of clause 34, wherein the additive has a concentration of one of 0.1-5% by volume, 1-5% by volume, 2-5% by volume, 2-5% by volume, 3-5% by volume, 4-5% by volume, 0.1-4% by volume, 0.1-3% by volume, 0.1-2% by volume, 0.1-1% by volume, 1-4% by volume, 1-3% by volume, and 1-2% by volume.

Clause 37. The liquid electrolyte of clause 34, wherein the additive has a concentration of one of one of 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M.

Clause 38. A lithium-metal battery comprising: a lithium-metal negative electrode; a positive electrode; and a liquid electrolyte of any one of clauses 1-37.

These and other embodiments are described further below with reference to the figures.

### BRIEF DESCRIPTION OF THE DRAWINGS

The included drawings are for illustrative purposes and serve only to provide examples of possible structures (e.g., lithium-metal negative electrodes comprising polymer base layers and current collector layers, formed from lithium-aluminum alloys such as a Li9Al4 alloy) and operations for the disclosed inventive systems, apparatus, and methods for fabricating such electrodes. These drawings in no way limit any changes in form and detail that may be made by one skilled in the art without departing from the spirit and scope of the disclosed implementations.

FIG. 1 is a schematic block diagram of a lithium-metal battery illustrating various components of the battery, including the electrolyte components, in accordance with various examples.

FIG. 2 is a graph of capacity comparison among 5 Ah lithium-metal pouch cells having the electrolyte formulations presented in the table below and identified as Example 1, Example 2, Example 3, Example 4, Example 5, Example 6, Example 7, Example 8, Example 9, Example 10, Example 11, and Example 12 that were cycled between 2.8 to 4.3 volts at 1 C charge and 2 C discharge at 23° C.

FIG. 3 is a graph of capacity comparison among 5 Ah lithium metal pouch cells having the electrolyte formulations presented in the table below and identified as Example 1, Example 13, Example 14, Example 15, Example 16, and Example 17 that were cycled between 2.8 and 4.3 volts at 1 C charge and 2 C discharge at 23° C.

FIG. 4 is a graph of capacity comparison among 5 Ah lithium metal pouch cells having the electrolyte formulations presented in the table below and identified as Example 18, Example 19, Example 20, Example 21, Example 22, Example 23, and Example 24 that were cycled between 2.8 and 4.3 volts at 1 C charge and 2 C discharge at 23° C.

FIG. 5 is a graph of capacity (ampere hour, Ah) at 45° C. versus cycle number when a 5 Ah lithium metal pouch cell having the electrolyte formulations presented in the table below and identified as Example 1 and Example 18 was cycled between 2.8 and 4.3 volts at C/3 charge and 1 C discharge.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscuring the described concepts. While some concepts will be described in conjunction with the specific embodiments, it will be understood that these embodiments are not intended to be limiting.

Reference to “about” a value or parameter herein includes (and describes) embodiments that are directed to that value or parameter per se. For example, a description referring to “about X” includes a description of “X”. In some embodiments, the term “about” when used in association with a measurement, or used to modify a value, a unit, a constant, or a range of values, refers to variations of ±10%, ±5%, or ±2%.

Reference to “between” two values or parameters herein includes (and describes) embodiments that include those two values or parameters per se. For example, a description referring to “between x and y” includes a description of “x” and “y” per se.

It is understood that aspects and variations described herein also include “consisting” and/or “consisting essentially of” aspects and variations. For purposes of this disclosure, the term “consisting essentially of” is defined as additional components having a concentration of less than 5% by volume, less than 2% by volume, or even less than 1% by volume.

“Combinations” are inclusive of blends, mixtures, alloys, reaction products, and the like. The terms “a”, “an”, and “the” do not denote a limitation of quantity and are to be construed to cover both the singular and the plural, unless otherwise indicated herein or clearly contradicted by context. “Or” means “and/or” unless clearly stated otherwise. A “combination thereof” is open and includes any combination comprising at least one of the listed components or properties, optionally together with a like or equivalent component or property not listed.

“Alkyl” as used herein refers to and includes, unless otherwise stated, a saturated linear (i.e., unbranched) or branched univalent hydrocarbon chain or a combination thereof, having the number of carbon atoms designated (i.e., C1-C2 means one to two carbon atoms). Examples of alkyl groups include, but are not limited to, groups such as methyl, ethyl, and the like.

“Anode-free” as used herein indicates that at manufacture the cell does not contain an anode (negative) active material on the anode current collector, for example, when lithium metal is deposited on the anode current collector on charge to provide lithium as the anode active material.

“Fluoroalkyl” refers to an alkyl group in which one or more hydrogen atoms have been substituted for fluorine.

“Anodes” and “negative electrodes” are used herein interchangeably to differentiate electrodes in a battery, independent of the electrode potential. Similarly, “cathodes” and “positive electrodes” are used interchangeably.

Finally, “electrochemical cells”, “cells”, and “batteries” are used herein interchangeably.

### Introduction

Lithium-metal batteries offer high energy density and are considered a promising technology for next-generation batteries. However, conventional electrolytes used in lithium-ion batteries face significant challenges when applied to lithium-metal negative electrodes/anodes. One of the most critical problems in lithium-metal batteries is the formation of lithium dendrites. Dendrites are needle-like structures that grow on the lithium-metal anode during repeated charge/discharge cycles. Conventional liquid electrolytes, typically composed of lithium salts (e.g., LiPF₆) dissolved in organic solvents (such as ethylene carbonate and dimethyl carbonate), do not effectively suppress dendrite growth. Dendrites can pierce the separator and cause internal short circuits, leading to potential thermal runaway and battery failure. Additionally, dendrites can accelerate capacity degradation due to uneven lithium deposition.

Furthermore, lithium-metal anodes have an extremely low electrochemical potential, making them highly reactive with conventional electrolytes. This reactivity leads to electrolyte decomposition, forming a passivation layer known as the Solid Electrolyte Interphase (SEI). An unstable SEI leads to continuous electrolyte consumption, increasing the internal resistance and reducing cycle life.

Most conventional electrolytes use flammable organic solvents, making lithium-metal batteries prone to thermal runaway. When combined with dendrite growth and electrolyte decomposition, the risk of fire or explosion increases significantly.

Novel electrolytes (formulated specifically for lithium-metal batteries and described herein) comprise steric ethers for local high-concentration electrolytes (LHCEs). Different steric ethers were tested in 5 Ah lithium-metal batteries, with most demonstrating great capabilities in terms of cycle life and stability. Compared to previously reported LHCEs, the steric ether-based electrolytes disclosed herein enable longer cycle life, better high-temperature performance, lower gassing concerns, and better safety.

LHCEs are an emerging category of electrolyte formulations designed to improve the performance and safety of lithium-metal batteries. LHCEs help suppress dendrite formation through higher lithium-ion transportation and a stable solvation structure. While conventional high-concentration electrolytes (HCEs) offer stability benefits, these conventional electrolytes suffer from high viscosity and poor ionic conductivity, which limits battery performance. LHCEs address this issue by incorporating a diluent solvent that could maintain low viscosity, thereby enhancing ionic transport.

The high concentration of lithium salt in localized regions enables more uniform lithium-ion flux, reducing uneven lithium deposition. Unlike conventional electrolytes, where free solvent molecules promote dendrite growth, LHCEs have a structured solvation sheath that limits side reactions and enhances lithium plating uniformity. This leads to a more robust and stable Solid Electrolyte Interphase (SEI), which protects the lithium metal and enhances cycle life.

In addition to steric ethers, some examples of electrolyte formulations further include tertiary partially fluorinated ethers (e.g., F4 and/or F5). For example, combining 1,2-diethoxyethane (DEE, a steric ether), 1,1,2,2-tetrafluoroethyl 2,2,3,3-tetrafluoropropylether (TTE, a diluent), and F4 and/or F5 (tertiary partially fluorinated ethers), the electrolyte further promotes the overall battery performance and thermal stability without trading off the cycle life. Compared to the electrolytes without tertiary partially fluorinated ethers, the electrolytes with tertiary partially fluorinated ethers in addition to steric ethers demonstrated longer cycle life, better high-temperature performance, lower gassing issues, and better safety features.

Overall, the introduction of steric ethers in electrolyte formulations for lithium-metal battery design greatly benefits the cycle life of these batteries. Furthermore, blending LHCEs with steric ethers and, in some examples, electrolyte formulations include tertiary partially fluorinated ethers (e.g., F4 and F5), which are non-flammable, will boost the battery performance and thermal stability without trading off the cycle life. Specifically, new molecules designed for LHCE-based formulations power lithium-metal batteries and enable a higher charging/discharging rate.

### Examples of Lithium-Metal Electrochemical Cells

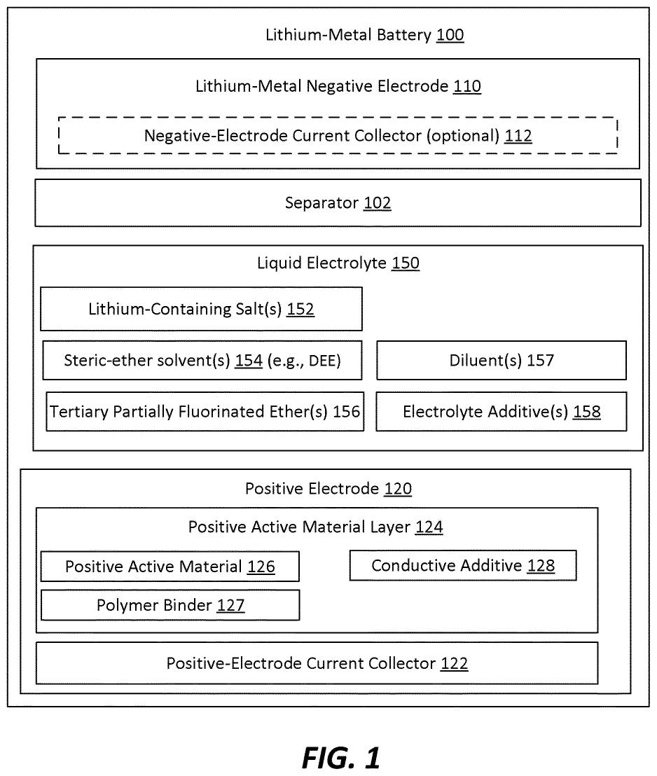

FIG. 1 is a schematic block diagram of a lithium-metal battery 100 comprising a lithium-metal negative electrode 110, a positive electrode 120, a separator 102, and a liquid electrolyte 150 providing an ionic pathway between the lithium-metal negative electrode 110 and the positive electrode 120 (when charging/discharging the lithium-metal battery 100). The separator 102 provides a physical separation and electronic isolation of the lithium-metal negative electrode 110 and positive electrode 120. Each of these components will now be described in more detail.

Lithium-metal negative electrode 110 may be in the form of lithium foil, in which this foil is operable both as a negative active material and a current collector. For the purposes of this disclosure, an active material is defined as a material (on an electrode) whose components shuttle between the electrodes during charging/discharging cells. In lithium-metal batteries, the negative active material is lithium metal, while the positive active material is a component that is capable of receiving lithium while charging the cell. In some examples, the current collector of the lithium-metal negative electrode 110 may have a non-lithium conductive structure, e.g., a copper foil supporting a lithium-metal layer. In this example, the current collector may also be referred to as a negative-electrode current collector 112. This example allows for minimizing the total amount of lithium metal in the lithium-metal battery 100.

A positive electrode 120 can include a positive-electrode current collector 122 and a positive active material layer 124. The positive-electrode current collector 122 may be a standalone layer (e.g., an aluminum foil). The positive active material layer 124 is supported on the positive-electrode current collector 122, which also provides an electronic pathway to the battery terminal. The positive active material layer 124 comprises positive active material 126 (e.g., in the form of particles) and binder 127 (e.g., a polymer binder). Some examples of positive active materials 126 include, but are not limited to, lithium nickel manganese cobalt (NMC) oxides, lithium iron phosphate, and the like. Some examples of suitable polymer binders 137 include, but are not limited to, polymer binders (e.g., polyvinylidene-fluoride (PVDF), styrene-butadiene rubber (SBR), and carboxyl methyl cellulose (CMC)). In some examples, positive electrode 120 comprises conductive additive 128 (e.g., carbon black/paracrystalline carbon).

As noted above, a liquid electrolyte 150 provides ionic (lithium ions) transfer between the lithium-metal negative electrode 110 and positive electrode 120, e.g., through the pores of separator 102. Liquid electrolyte 150 should be distinguished from solid and gel electrolytes used in other types of lithium-metal cells. Liquid electrolyte 150 should be distinguished from gel electrolytes, in which polymer matrices are used to retain salts and solvents. The liquid electrolyte 150 described herein is free from polymer components such as polyacrylonitrile (PAN), polymethylmethacrylate (PMMA), polyvinylchloride (PVC), and polyvinylidene fluoride (PVDF) and has a viscosity of less than 1,000 cP, less than 500 cP, or less than 200 cP at the room temperature (e.g., to differentiate the liquid electrolyte 190 from gel electrolytes and solid electrolytes).

The liquid electrolyte 150 comprises a lithium-containing salt 152 such as lithium bis(fluorosulfonyl)imide (LiFSI), lithium bis(trifluoromethanesulfonyl)imide (LiTFSI), lithium bis(pentafluoroethanesulfonyl)imide (LiBETI), lithium hexafluorophosphate (LiPF6), lithium hexafluoroarsenate (LiAsF6), lithium tetrafluoroborate (LiBF4), lithium bis(oxalato)borate (LiBOB), lithium difluoro(oxalato)borate (LiDFOB), lithium difluorophosphate (LiDFP), lithium difluoro(dioxalato)phosphate (LiDFDOP), lithium tetrafluoro(oxalato)phosphate (LiTFOP), lithium nitrate (LiNO3), lithium perchlorate (LiClO4), lithium triflate (LiTf), lithium trifluoroacetate (LiTFA), lithium 4,5-dicyano-2-(trifluoromethyl)imidazole (LiTDI). In some examples, the lithium-containing salt 152 is lithium bis(fluorosulfonyl)imide (LiFSI). It is believed that LiFSI provides improved anode stability, better ion conductivity, and lower viscosity in comparison to other types of lithium-containing salts. In some examples, the concentration of the lithium-containing salt 152 in the liquid electrolyte 150 is at least 1M, at least 1.5M, at least 2M, at least 2.5M, or even at least 3.0M. For example, the concentration of the lithium-containing salt 152 in the liquid electrolyte 150 may be between 1-4M, 1.5-4M, 2-4M, 2.5-4M, 3-4M, 3.5-4M, 1-3.5M, 1-3M, 1-2.5M, 1-2M, or 1-1.5M.

It should be noted that in local high-concentration electrolytes (LHCEs), lithium-containing salt 152 is only dissolved in steric ethers and F5 but not in TTE. For example, in FSI in DEE/TTE 1/2 (Example 1), the relative FSI concentration is around 3 to 6M in DEE only.

The liquid electrolyte 150 also comprises a steric-ether solvent 154 selected from the group consisting of 1,2-dimethoxy propane (DMIP), methyl (3-methoxypropyl) ether (MMPE), 2,2-difluoro-1,3-diethoxy propane (FDEPr), 1,2-diethoxyethane (DEE), 1-methoxy 2-ethoxy ethane (MEE), 2-(2-(2,2-difluoroethoxy)ethoxy)-ethane (F2EE), 1-propoxy 2-methoxy ethane (PME), 1-isopropoxy 2-methoxy ethane (IPME), 2-(2,2-difluoroethoxy)ethoxy methane (F2ME), 1-propoxy 2-ethoxy ethane (PEE), 1-isopropoxy 2-ethoxy ethane (IPEE), and 2-(2,2,2-trifluoroethoxy)ethoxy methane (F3ME). The table below illustrates the corresponding formulas of these steric-ether solvents.

| Full Chemical Name | Acronyms | Formula |
|---|---|---|
| 1,2-dimethoxy propane | DMIP | 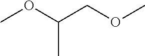 |
| methyl (3-methoxypropyl) ether | MMPE | 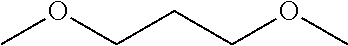 |
| 2,2-difluoro-1,3-diethoxy propane | FDEPr | 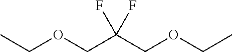 |
| 1,2-diethoxyethane | DEE | 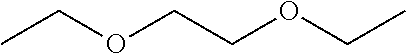 |
| 1-methoxy 2-ethoxy ethane | MEE | 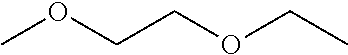 |
| 2-(2-(2,2-difluoroethoxy)ethoxy)- ethane | F2EE | 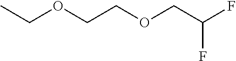 |
| 1-propoxy 2-methoxy ethane | PME | 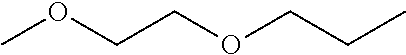 |
| 1-isopropoxy 2-methoxy ethane | IPME | 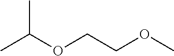 |
| 2-(2,2-difluoroethoxy)ethoxy methane | F2ME | 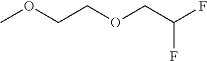 |
| 1-propoxy 2-ethoxy ethane | PEE | 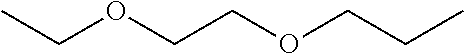 |
| 1-isopropoxy 2-ethoxy ethane | IPEE | 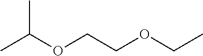 |
| 2-(2,2,2-trifluoroethoxy) ethoxy methane | F3ME | 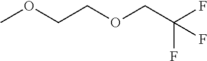 |

In some examples, the steric-ether solvent 154 is 1-isopropoxy 2-ethoxy ethane (IPEE). The IPEE demonstrated one of the best performances when combined with 1,1,2,2-tetrafluoroethyl 2,2,3,3-tetrafluoropropylether (TTE) as in Example 9 presented below. In other examples, the steric-ether solvent 155 is 1,2-diethoxyethane (DEE), e.g., in Examples 1 and 13-24 below.

A liquid electrolyte 150 may comprise one or more tertiary partially fluorinated ethers 156, such as 1-ethoxy-2-(2-fluoroethoxy)ethane (F1); 2-(2-ethoxyethoxy)-1,1-difluoroethane (F2); 1,2-bis(2-fluoroethoxy)ethane (F1F1); 1,1-difluoro-2-(2-(2-fluoroethoxy)ethoxy)ethane (F1F2); 1,1,1-trifluoro-2-(2-(2-fluoroethoxy)ethoxy)ethane (F1F3); 2-(2-ethoxyethoxy)-1,1,1-trifluoroethane (F3); 1,2-bis(2,2-difluoroethoxy)ethane (F4); 2-(2-(2,2-difluoroethoxy)ethoxy)-1,1,1-trifluoroethane (F5). and 1,2-bis(2,2,2-trifluoroethoxy)ethane (F6). The corresponding formulas are presented below.

| Full Chemical Name | Acronyms | Formula |
|---|---|---|
| 1-ethoxy-2-(2-fluoroethoxy)ethane | F1 | 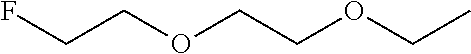 |
| 1,2-bis(2-fluoroethoxy)ethane | F1F1 | 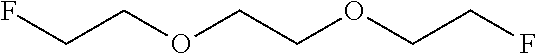 |
| 1,1-difluoro-2-(2-(2- fluoroethoxy)ethoxy)ethane | F1F2 | 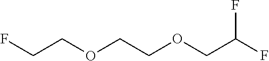 [SMILES: FCCOCCOCC(F)F] |
| 1,1,1-trifluoro-2-(2-(2- fluoroethoxy)ethoxy)ethane | F1F3 | 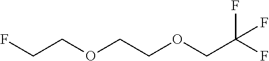 [SMILES: FCCOCCOCC(F)(F)F] |
| 2-(2-ethoxyethoxy)-1,1,1- trifluoroethane | F3 | 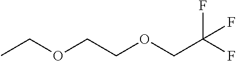 |
| 1,2-bis(2,2-difluoroethoxy)ethane | F4 | 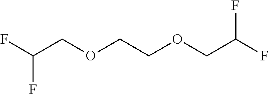 [SMILES: FC(F)COCCOCC(F)F] |
| 2-(2-(2,2-difluoroethoxy)ethoxy)- 1,1,1-trifluoroethane | F5 | 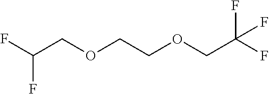 [SMILES: FC(F)COCCOCC(F)(F)F] |
| 1,2-bis(2,2,2-trifluoroethoxy)ethane | F6 | 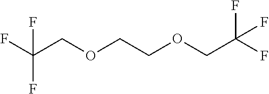 [SMILES: FC(F)(F)COCCOCC(F)(F)F] |

In some examples, the tertiary partially fluorinated ether 156 is 1,2-bis(2,2-difluoroethoxy)ethane (F4); 2-(2-(2,2-difluoroethoxy)ethoxy)-1,1,1-trifluoroethane (F5). The existence of the —CHF₂ group in these two molecules not only provides both lithium metal and high-voltage stability resulting from the fluorination but also high ionic conductivity due to its local dipole interaction. In the meantime, the CHF₂ group eliminates the per- and polyfluoroalkyl substances (PFAS) concerns. Tertiary partially fluorinated ethers 156 should be differentiated from steric-ether solvents 154 described above. However, tertiary partially fluorinated ethers 156 and steric-ether solvents 154 are capable of dissolving lithium-containing salts 152.

Furthermore, a liquid electrolyte 150 may comprise one or more diluents 157, such as bis(2,2,2-trifluoroethyl) ether (BTFE), 1,1,2,2-tetrafluoroethyl-2,2,3,3-tetrafluoropropyl ether (TTE), 1H,1H,5H-octafluoropentyl-1,1,2,2-tetrafluoroethylether (OTE), 2,2,2-trifluoroethyl 1,1,2,2-tetrafluoroethyl ether (HFE), tris(2,2,2-trifluoroethyl) orthoformate (TFEO) and 1,2-bis(1,1,2,2-tetrafluoroethoxy)ethane (F8), 1,3-(1,1,2,2-Tetrafluoroethoxy)propane (F8P), fluorobenzene, 1,2-difluorobenzene, benzotrifluoride, (trifluoromethoxy)benzene, dichloromethane, toluene, and mixtures of any of the foregoing. In some examples, the diluent 157 is bis(2,2,2-trifluoroethyl) ether (BTFE), 1,1,2,2-tetrafluoroethyl-2,2,3,3-tetrafluoropropyl ether (TTE), 1,2-bis(1,1,2,2-tetrafluoroethoxy)ethane (F8), 1,3-(1,1,2,2-tetrafluoroethoxy)propane (F8P), fluorobenzene, benzotrifluoride, (trifluoromethoxy)benzene, toluene, and mixtures of any of the foregoing.

In some examples, the diluent 157 is bis(2,2,2-trifluoroethyl) ether (BTFE), 1,1,2,2-tetrafluoroethyl-2,2,3,3-tetrafluoropropyl ether (TTE), 1,2-bis(1,1,2,2-tetrafluoroethoxy)ethane (F8), 1,3-(1,1,2,2-tetrafluoroethoxy)propane (F8P), fluorobenzene, benzotrifluoride, (trifluoromethoxy)benzene, toluene, with the corresponding formula presented below. These examples tend to have a higher conductivity, a lower viscosity, and a higher boiling point, and are widely available.

| Full Chemical Name | Acronyms | Formula |
|---|---|---|
| bis(2,2,2-trifluoroethyl) ether | BTFE | 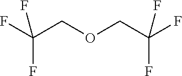 [SMILES: FC(F)(F)COCC(F)(F)F] |
| 1,1,2,2-Tetrafluoroethyl 2,2,3,3- tetrafluoropropylether | TTE | 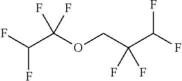 [SMILES: FC(F)C(F)(F)COC(F)(F)C(F)F] |
| 1,2-bis(1,1,2,2- tetrafluoroethoxy)ethane | F8 | 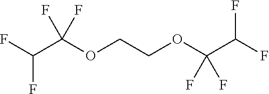 [SMILES: FC(F)C(F)(F)OCCOC(F)(F)C(F)F] |
| 1,3-(1,1,2,2- Tetrafluoroethoxy)propane | F8P | 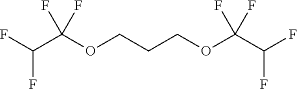 [SMILES: FC(F)C(F)(F)OCCCOC(F)(F)C(F)F] |
| fluorobenzene | FB | 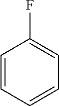 |
| benzotrifluoride | BTF | 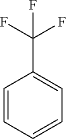 |
| (trifluoromethoxy)benzene | TFMOB | 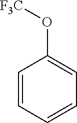 [SMILES: FC(F)(F)Oc1ccccc1] |
| toluene | MB | 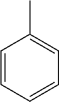 |

Unlike tertiary partially fluorinated ethers 156 and steric-ether solvents 154, diluents 157 may not dissolve lithium-containing salts 152, thereby creating locally high-concentrated electrolyte (LHCE) effects. For example, in the LiFSI in DEE:TTE formulation (corresponding to Example 1), the relative LiFSI concentration is 3 times higher in the DEE only (operable as a steric-ether solvent 154).

In some examples, the liquid electrolyte 150 also comprises a steric-ether solvent 154 and a diluent 157 (but no tertiary partially fluorinated ethers 156), e.g., as in Examples 1-17 below. In other examples, the liquid electrolyte 150 comprises both a diluent 157 and a tertiary partially fluorinated ether 156 (in addition to a steric-ether solvent 154), e.g., as in Examples 18-27 below. For example, the liquid electrolyte 150 may comprise a combination of 2-(2-(2,2-difluoroethoxy)ethoxy)-1,1,1-trifluoroethane (F5) and 1,1,2,2-tetrafluoroethyl 2,2,3,3-tetrafluoropropylether (TTE).

Without being restricted to any particular theory, it is believed that adding a diluent 157 facilitates the formation of an anion-derived solid electrolyte interface (SEI), which is beneficial for suppressing side reactions between lithium metal and electrolytes. Compared to adding diluent 157 to a fluorinated ether with a limited degree of fluorination, adding diluent to a nonfluorinated ether will more greatly reduce ionic conductivity while still improving cycle life, but to a lesser extent. Cycling results at low and high temperatures confirmed this conclusion. The steric ether-based electrolytes also enable fast charge and discharge of lithium metal batteries.

Additionally, through the tuning of solvent ratios and salt concentration, cycle life can be further improved. Electrolytes that feature 60% to 70% diluent show greater cycle life when compared to those with less than 60% diluent. For instance, this behavior is observed when comparing Example 1 (LiFSI in DEE:TTE) to Example 14 (LiFSI in Diluent) in Table 2 below, with Example 14 having a greater ratio of DEE:Diluent. This difference is due to the improved SEI formation that is promoted by the diluent. Moreover, increasing the salt concentration (e.g., from Example 1 to Example 14) by about 30-70% will further increase cycle life by providing a more abundant lithium inventory that can be drawn upon during cycling, e.g., as shown in Table 2 such as Example 14 (LiFSI in DEE:Diluent) vs. Example 16 (LiFSI in DEE:Diluent), which have the same ratio of DEE:Diluent. For these high-concentration electrolytes, it is once again favorable for 60% or more of the total solvent to be comprised of diluent.

The data also shows that introducing a third, partially fluorinated ether to the combination of a nonfluorinated ether (DEE) and diluent can greatly improve cycle life while only slightly reducing ionic conductivity. It is believed that the addition of this tertiary partially fluorinated solvent can vastly improve oxidative resistance, in turn, creating a more stable electrolyte with longer cycle life. Also, the blended electrolytes with three different ethers in a certain ratio could potentially become more thermally stable because F5 is non-flammable.

In some examples, the liquid electrolyte 150 further comprises one or more electrolyte additives 158. For purposes of this disclosure, electrolyte additives 158 are defined as a subset of electrolyte components with the combined concentration of less than 10% by volume or even less than 5% by volume. Electrolyte additives 158 may include a single component or a combination of multiple components. Some examples of electrolyte additives 158 include, but are not limited to, ethylene carbonate (EC), propylene carbonate (PC), dimethyl carbonate (DMC), diethyl carbonate (DEC), ethyl methyl carbonate (EMC), vinyl carbonate (VC), vinyl ethylene carbonate (VEC), fluoroethylene carbonate (FEC), difluoroethylene carbonate (DFEC), 3,3,3-trifluoropropylene carbonate (TFPC), 1,2-dimethyoxylethane (DME), 1,3-dioxolane (DOL), 1,4-dioxane (DOX), tetrahydrofuran (THF), acetonitrile (AN), ethyl acetate (EA), methyl acetate (MA), methyl propanoate (MP), ethyl propanoate (EP), propyl propanoate (PP), N,N-Dimethylformamide (DMF), gamma-butyrolactone (BL), succinic anhydride (SA), butyric anhydride (BA), tetravinyl silane (TVSI), succinonitrile (SN), adiponitrile (ADN), 1,3,6-Hexanetricarbonitrile (HTCN), trimethyl borate (TMB), triphenyl borate (TPB), triethyl borate (TEB), tris(pentafluorophenyl)borane (TPFPB), tris(trimethylsilyl)phosphate (TTSB), tris(2,2,2-trifluoroethyl) borate (TTFEB), trimethyl phosphate (TMP), triethyl phosphate (TEP), tris(trimethylsilyl)phosphate (TTSP), tris(trimethylsilyl)phosphite (TTSPi), tris(2,2,2-trifluoroethyl) phosphate (TFEPa), tris(2,2,2-trifluoroethyl) phosphite (TFEPi), (pentafluorophenyl)diphenyl phosphine (PFPDPP), tris(pentafluorophenyl) phosphine (TPFPP), ethoxy(pentafluoro)cyclotriphosphazene (PFPN), 1,3,2-dioxathiolane-2,2-dioxide (DTD), 1,3-propanesultone (PS), prop-1-ene-1,3-sultone (PES), propanediol cyclic sulfate (PCS), ethylene sulfite (ES), 1,4-butane sultone (BS), diphenyl sulfone (DPS), dimethyl sulfoxide (DMSO), 1,2,6-oxadithiane-2,2,6,6-tetraoxide (ODTO), methylene methanedisulfonate (MMDS), lithium bis(trifluoromethanesulfonyl)imide (LiTFSI), lithium bis(pentafluoroethanesulfonyl)imide (LiBETI), lithium hexafluorophosphate (LiPF), lithium hexafluoroarsenate (LiAsF6), lithium tetrafluoroborate (LiBF₄), lithium bis(oxalato)borate (LiBOB), lithium difluoro(oxalato)borate (LiDFOB), lithium difluorophosphate (LiDFP), lithium difluoro(dioxalato)phosphate (LiDFDOP), lithium tetrafluoro(oxalato)phosphate (LiTFOP), lithium nitrate (LiNO₃), lithium perchlorate (LiClO4), lithium triflate (LiTf), lithium trifluoroacetate (LiTFA), lithium 4,5-dicyano-2-(trifluoromethyl)imidazole (LiTDI), sodium hexafluorophosphate (NaPF6), sodium bis(fluorosulfonyl)imide (NaFSI), sodium bis(trifluoromethanesulfonyl)imide (NaTFSI), sodium triflate (NaTf), sodium bis(pentafluoroethanesulfonyl)imide (NaBETI), potassium hexafluorophosphate (KPF₆), potassium bis(fluorosulfonyl)imide (KFSI), potassium bis(trifluoromethanesulfonyl)imide (KTFSI), potassium triflate (KTf), cesium bis(fluorosulfonyl)imide (CsFSI), cesium bis(trifluoromethanesulfonyl)imide (CsTFSI), magnesium bis(trifluoromethanesulfonyl)imide (Mg(TFSI)₂), zinc bis(trifluoromethanesulfonyl)imide (Zn(TFSI)₂), calcium bis(trifluoromethanesulfonyl)imide (Ca(TFSI)₂), silver bis(trifluoromethanesulfonyl)imide (AgTFSI), aluminum bis(trifluoromethanesulfonyl)imide (Al(TFSI)3), and lanthanum bis(trifluoromethanesulfonyl)imide (La(TFSI)₃). Electrolyte additives 158 may provide various functionalities in the liquid electrolyte 150.

In some examples, the electrolyte additive 158 in the liquid electrolyte 150 may be diphenyl sulfone (DPS) with a concentration of 0.1-5% by volume, 1-5% by volume, 2-5% by volume, 2-5% by volume, 3-5% by volume, 4-5% by volume, 0.1-4% by volume, 0.1-3% by volume, 0.1-2% by volume, 0.1-1% by volume, 1-4% by volume, 1-3% by volume, and 1-2% by volume. The amount depends on the other components of the liquid electrolyte 150 and desired functionality from the electrolyte additive 158, e.g., DPS used as an additive may help to eliminate gassing and improve high-voltage stability.

In some examples, the additive 158 in the liquid electrolyte 150 is lithium difluoro(oxalato)borate (DFOB) with a concentration of 0.1-5% by volume, 1-5% by volume, 2-5% by volume, 2-5% by volume, 3-5% by volume, 4-5% by volume, 0.1-4% by volume, 0.1-3% by volume, 0.1-2% by volume, 0.1-1% by volume, 1-4% by volume, 1-3% by volume, and 1-2% by volume. In some examples, the additive 158 in the liquid electrolyte 150 is lithium difluorophosphate (DFP) with a concentration of 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is lithium bis(oxalato)borate (BOB) with a concentration of 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is lithium tetrafluoroborate (BF4) with a concentration of 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is lithium bis(trifluoromethanesulfonyl)imide (LiTFSI) with a concentration of 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is lithium hexafluorophosphate (LiPF6) with a concentration of 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is lithium hexafluorophosphate (LiPF₆) with a concentration of 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is a combination of lithium bis(oxalato)borate (BOB) and lithium difluoro(oxalato)borate (DFOB), with the concentration of each of lithium bis(oxalato)borate (BOB) and lithium difluoro(oxalato)borate (DFOB) in the liquid electrolyte 150 is 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is a combination of lithium tetrafluoroborate (BF₄) and lithium difluoro(oxalato)borate (DFOB), with the concentration of each of lithium tetrafluoroborate (BF₄) and lithium difluoro(oxalato)borate (DFOB) in the liquid electrolyte 150 is 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is a combination of lithium tetrafluoroborate (BF4) and lithium bis(oxalato)borate (BOB), with the concentration of each of lithium tetrafluoroborate (BF4) and lithium bis(oxalato)borate (BOB) in the liquid electrolyte 150 is 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is a combination of lithium difluorophosphate (DFP) and lithium bis(oxalato)borate (BOB), with the concentration of each of lithium difluorophosphate (DFP) and lithium bis(oxalato)borate (BOB) in the liquid electrolyte 150 is 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is a combination of lithium difluorophosphate (DFP) and lithium difluoro(oxalato)borate (DFOB) with the concentration of each of lithium difluorophosphate (DFP) and lithium difluoro(oxalato)borate (DFOB) in the liquid electrolyte 150 is 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is a combination of lithium difluorophosphate (DFP) and lithium tetrafluoroborate (BF₄) with the concentration of each of lithium difluorophosphate (DFP) and lithium tetrafluoroborate (BF₄) in the liquid electrolyte 150 is 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M. In some examples, the additive 158 in the liquid electrolyte 150 is a combination of lithium bis(trifluoromethanesulfonyl)imide (LiTFSI), lithium hexafluorophosphate (LiPF6), lithium difluoro(oxalato)borate (DFOB), lithium bis(oxalato)borate (BOB), lithium difluorophosphate (DFP) and lithium tetrafluoroborate (BF₄) with the concentration of each of lithium bis(trifluoromethanesulfonyl)imide (LiTFSI), lithium hexafluorophosphate (LiPF6), lithium difluoro(oxalato)borate (DFOB), lithium bis(oxalato)borate (BOB), lithium difluorophosphate (DFP), lithium tetrafluoroborate (BF₄), ethoxy(pentafluoro)cyclotriphosphazene (PFPN), 1,3,2-dioxathiolane-2,2-dioxide (DTD), 1,3-propanesultone (PS), prop-1-ene-1,3-sultone (PES), propanediol cyclic sulfate (PCS), and diphenyl sulfone (DPS) in the liquid electrolyte 150 is 0.01-0.5M, 0.1-0.5M, 0.2-0.5M, 0.3-0.5M, 0.4-0.5M, 0.01-0.4M, 0.01-0.3M, 0.01-0.2M, 0.01-0.1M, 0.1-0.4M, 0.1-0.3M, and 0.1-0.2M.

### Experimental Results

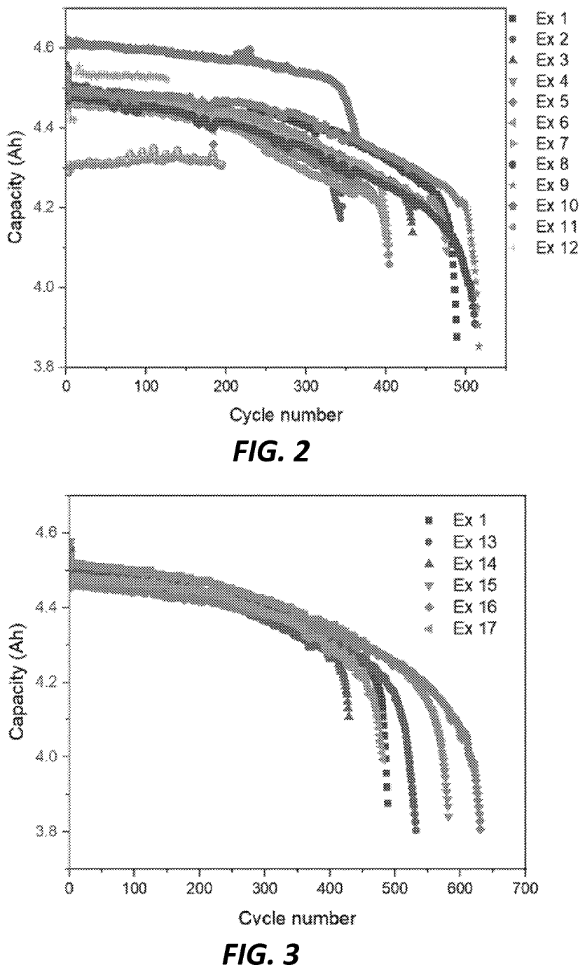

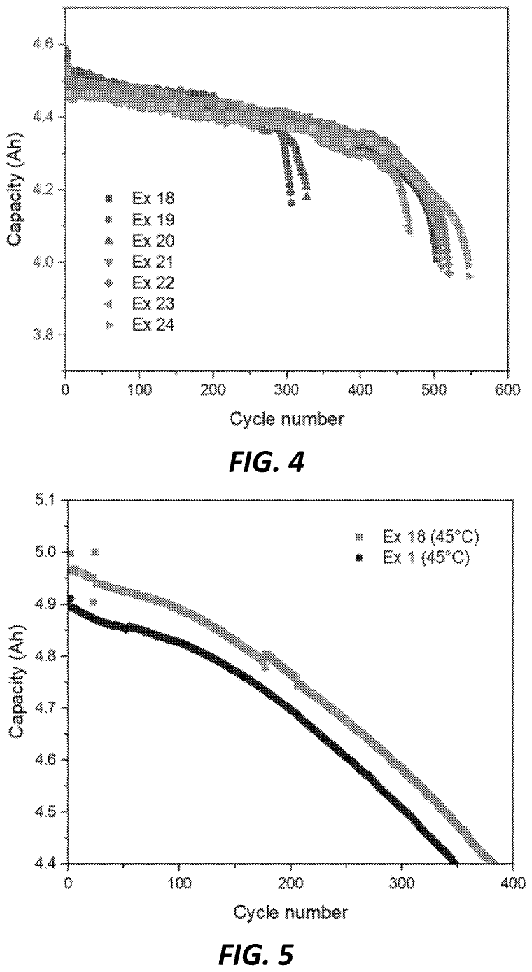

As noted above, different steric ethers were tested in 5 Ah lithium-metal batteries with most demonstrating great capabilities in terms of cycle life and stability, with a cycle life often exceeding 400 cycles, 500 cycles, and even 600 cycles (cycled between 2.8 to 4.3 volts at 1 C charge and 2 C discharge at 23° C.). These steric ethers were combined with 1,1,2,2-tetrafluoroethyl 2,2,3,3-tetrafluoropropylether (TTE) as a diluent. In some examples, 2-(2-(2,2-difluoroethoxy)ethoxy)-1,1,1-trifluoroethane (F5) was also used as a tertiary partially fluorinated ether. Furthermore, different additives were tested at different concentrations in some examples. Finally, different salt concentrations were tested. The results are presented in Tables 1-3 below as well as FIGS. 2-5.

All tested electrolytes shown in the tables below contained lithium bis(fluorosulfonyl)imide (LiFSI) as a salt. However, Example 13, Example 15, and Example 16 had a higher concentration of LiFSI by about 30-60% relative to all other examples. These different electrolyte concentrations allowed the determination of the effects of different solvents and diluents on forming the local high-concentration electrolytes (LHCEs). For example, the electrolytes in Examples 1-17 included a diluent (namely, 1,1,2,2-tetrafluoroethyl-2,2,3,3-tetrafluoropropylether (TTE)) in addition to a steric-ether solvent. Examples 18-24 contained another co-solvent (i.e., a tertiary partially fluorinated ether or, more specifically, 2-(2-(2,2-difluoroethoxy)ethoxy)-1,1,1-trifluoroethane (F5)) with or without different additives.

The control electrolytes for Table 1 and Table 2 were formulated with LiFSI in nonfluorinated diethoxy ether (DEE) with TTE in a volume ratio (and identified as Example 1).

The control electrolytes for Table 3 were formulated with LiFSI in DEE, TTE, and F5 (identified as Example 18). Example 20 to Example 24 also contained additives, including lithium tetrafluoroborate (LiBF4), lithium bis(oxalato)borate (LiBOB), lithium difluoro(oxalato)borate (LiDFOB), lithium difluorophosphate (LiDFP), lithium bis(trifluoromethanesulfonyl)imide (LiTFSI), lithium hexafluorophosphate (LiPF6), ethoxy(pentafluoro)cyclotriphosphazene (PFPN), 1,3,2-dioxathiolane-2,2-dioxide (DTD), 1,3-propanesultone (PS), prop-1-ene-1,3-sultone (PES), propanediol cyclic sulfate (PCS), and diphenyl sulfone (DPS).

Cycle life was tested using 5 Ah lithium metal pouch cells with nickel-manganese-cobalt (NMC) cathodes, aluminum or copper current collectors, and a free-standing polyethylene (PE) separator. The 5 Ah lithium metal pouch cells (Example 1 to Example 24) were cycled between 2.8 and 4.3 V at 1C charging and 2C discharge at room temperature. The results are summarized in the table below. The capacity retention and Coulombic efficiencies of the lithium metal pouch cells containing the electrolytes of Example 1 to Example 24 are also shown in FIGS. 1-5.

TABLE 1

| | Solvent 1 - | Solvent 2 - | Solvent 1:2 | | Cycle |
|---|---|---|---|---|---|
| # | Steric Ether | Diluent | vol ratio | Salt | life |
| Example 1 | DEE | TTE | 0.2-1 | LiFSI | 489 |
| Example 2 | F2EE | TTE | 0.2-1 | LiFSI | 345 |
| Example 3 | PME | TTE | 0.2-1 | LiFSI | 433 |
| Example 4 | PEE | TTE | 0.2-1 | LiFSI | 475 |
| Example 5 | MEE | TTE | 0.2-1 | LiFSI | 404 |
| Example 6 | DMIP | TTE | 0.2-1 | LiFSI | 402 |
| Example 7 | IPME | TTE | 0.2-1 | LiFSI | 402 |
| Example 8 | MMPE | TTE | 0.2-1 | LiFSI | 511 |
| Example 9 | IPEE | TTE | 0.2-1 | LiFSI | 520 |
| Example 10 | F2ME | TTE | 0.2-1 | LiFSI | 348 |
| Example 11 | F3ME | TTE | 0.2-1 | LiFSI | 196 |
| Example 12 | FDEPr | TTE | 0.3-2 | LiFSI | 127 |

TABLE 2

| | | | Solvent | | |
|---|---|---|---|---|---|
| | Solvent 1 - | Solvent 2 - | 1:2 vol | | Cycle |
| # | Steric Ether | Diluent | ratio | Salt | life |
| Example 1 | DEE | TTE | 0.2-1 | LiFSI | 489 |
| Example 13 | DEE | Diluent Example | 0.5-3 | LiFSI | 532 |
| Example 14 | DEE | Diluent Example | 0.2-1 | LiFSI | 429 |
| Example 15 | DEE | Diluent Example | 0.3-2 | LiFSI | 582 |
| Example 16 | DEE | Diluent Example | 0.2-1 | LiFSI | 631 |
| Example 17 | DEE | Diluent Example | 0.2-1 | LiFSI | 481 |

TABLE 3

| | Solv 1 - | | | Solvents | Solvents | | | |
|---|---|---|---|---|---|---|---|---|
| | Steric | Solv 2 - | | 1:2 vol. | 2:3 vol. | | | Cycle |
| Ex. | Ether | Diluent | Solv 3 | ratio | ratio | Additives | Salt | life |
| Example 18 | DEE | TTE | F5 | 0.2-1 | 0.5-3 | No | LiFSI | 503 |
| Example 19 | DEE | Diluent | (TPFE) | 0.2-1 | 0.3-2 | No | LiFSI | 306 |
| Example 20 | DEE | Diluent | (TPFE) | 0.2-1 | 0.5-3 | Yes | LiFSI | 327 |
| Example 21 | DEE | Diluent | (TPFE) | 0.2-1 | 0.5-3 | Yes | LiFSI | 510 |
| Example 22 | DEE | Diluent | (TPFE) | 0.2-1 | 0.5-3 | Yes | LiFSI | 520 |
| Example 23 | DEE | Diluent | (TPFE) | 0.2-1 | 0.5-3 | Yes | LiFSI | 467 |
| Example 24 | DEE | Diluent | (TPFE) | 0.2-1 | 0.5-3 | Yes | LiFSI | 547 |

(TPFE)=tertiary partially fluorinated ether (one of the examples listed above)

From the experimental results, Example 16 performs best. This performance can be attributed to the greater amount of LiFSI than in other formulations. This is confirmed through the tests that use identical salt concentrations and solvent ratios with different solvents. While even higher concentrations of LiFSI could prove advantageous, it is likely that the solubility of the salt in the solvent will decrease, and other important electrolyte properties (such as viscosity) will be negatively impacted.

Furthermore, the performance was improved significantly by using innovative additives, e.g., comparing Example 24 to Example 1. The solubility of additives is improved with increasing amounts of a fluorinated diether with a limited degree of fluorination.

Based on the data presented in Tables 1-3, it can be concluded that a high-performing, safe, and stable locally high-concentrated electrolyte (LHCE) can be synthesized by combining LiFSI salt, a fluorinated diether with a limited degree of fluorination, a dilutant and a third, more heavily fluorinated solvent in a ratio where the total amount of solvent is less than or equal to the total amount of dilutant. This LHCE can be further enhanced by incorporating additives.

It should also be noted that further improvements in cycle life were observed when a tertiary partially fluorinated ether was introduced. This cycle life enhancement, coupled with tertiary partially fluorinated ethers being non-flammable and more oxidatively stable than DEE, suggests that the addition of a tertiary partially fluorinated ether to an established LHCE enhances performance, safety, and cell stability.

It also becomes evident that some steric-ether solvents can potentially outperform the DEE baseline. Furthermore, adding a tertiary partially fluorinated ether to new steric-ether solvents can potentially further improve the performance.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A liquid electrolyte for a lithium-metal battery, the liquid electrolyte comprising:
a lithium-containing salt having a concentration of at least 1.5M in the liquid electrolyte;
a steric-ether solvent selected from the group consisting of 1,2-dimethoxy propane (DMIP), methyl (3-methoxypropyl) ether (MMPE), 2,2-difluoro-1,3-diethoxy propane (FDEPr), 1,2-diethoxyethane (DEE), 1-methoxy 2-ethoxy ethane (MEE), 2-(2-(2,2-difluoroethoxy)ethoxy)-ethane (F2EE), 1-propoxy 2-methoxy ethane (PME), 1-isopropoxy 2-methoxy ethane (IPME), 2-(2,2-difluoroethoxy)ethoxy methane (F2ME), 1-propoxy 2-ethoxy ethane (PEE), 1-isopropoxy 2-ethoxy ethane (IPEE), and 2-(2,2,2-trifluoroethoxy)ethoxy methane (F3ME); and
a diluent.

2. The liquid electrolyte of claim 1, wherein the diluent comprises one or more materials selected from the group consisting of bis(2,2,2-trifluoroethyl) ether (BTFE), 1,1,2,2-tetrafluoroethyl-2,2,3,3-tetrafluoropropyl ether (TTE), 1H,1H,5H-octafluoropentyl-1,1,2,2-tetrafluoroethylether (OTE), 2,2,2-trifluoroethyl 1,1,2,2-tetrafluoroethyl ether (HFE), tris(2,2,2-trifluoroethyl) orthoformate (TFEO) and 1,2-bis(1,1,2,2-tetrafluoroethoxy)ethane (F8), 1,3-(1,1,2,2-Tetrafluoroethoxy)propane (F8P), fluorobenzene, 1,2-difluorobenzene, benzotrifluoride, (trifluoromethoxy)benzene, dichloromethane, toluene, and mixtures of thereof.

3. The liquid electrolyte of claim 1, wherein the diluent is 1,1,2,2-tetrafluoroethyl 2,2,3,3-tetrafluoropropylether (TTE).

4. The liquid electrolyte of claim 1, wherein the lithium-containing salt has a concentration of at least 2M.

5. The liquid electrolyte of claim 1, wherein the lithium-containing salt is selected from the group consisting of lithium bis(fluorosulfonyl)imide (LiFSI), lithium bis(trifluoromethanesulfonyl)imide (LiTFSI), lithium hexafluorophosphate (LiPF6), lithium difluoro(oxalato)borate (LiDFOB), and lithium difluorophosphate.

6. The liquid electrolyte of claim 1, wherein the lithium-containing salt is lithium bis(fluorosulfonyl)imide (LiFSI).

7. The liquid electrolyte of claim 1, wherein the steric-ether solvent is one or more of 1,2-dimethoxy propane (DMIP), methyl (3-methoxypropyl) ether (MMPE), 2,2-difluoro-1,3-diethoxy propane (FDEPr), 1-methoxy 2-ethoxy ethane (MEE), 2-(2-(2,2-difluoroethoxy)ethoxy)-ethane (F2EE), 1-propoxy 2-methoxy ethane (PME), 1-isopropoxy 2-methoxy ethane (IPME), 2-(2,2-difluoroethoxy)ethoxy methane (F2ME), 1-propoxy 2-ethoxy ethane (PEE), 2-(2,2,2-trifluoroethoxy)ethoxy methane (F3ME), 1-isopropoxy 2-ethoxy ethane (IPEE), and 1,1,2,2-tetrafluoroethyl 2,2,3,3-tetrafluoropropylether (TTE).

8. The liquid electrolyte of claim 1, wherein a volumetric ratio of the steric-ether solvent to the diluent is between 1:3 and 1:1.

9. The liquid electrolyte of claim 1, wherein the liquid electrolyte consists essentially of:
lithium bis(fluorosulfonyl)imide (LiFSI) operable as the lithium-containing salt,
1-isopropoxy 2-ethoxy ethane (IPEE) operable as the steric-ether solvent, and
1,1,2,2-tetrafluoroethyl 2,2,3,3-tetrafluoropropylether (TTE) operable as the diluent.

10. The liquid electrolyte of claim 1, further comprising a tertiary partially fluorinated ether.

11. The liquid electrolyte of claim 10, wherein the tertiary partially fluorinated ether is selected from the group consisting of 1-ethoxy-2-(2-fluoroethoxy)ethane (F1); 2-(2-ethoxyethoxy)-1,1-difluoroethane (F2); 1,2-bis(2-fluoroethoxy)ethane (F1F1); 1,1-difluoro-2-(2-(2-fluoroethoxy)ethoxy)ethane (F1F2); 1,1,1-trifluoro-2-(2-(2-fluoroethoxy)ethoxy)ethane (F1F3); 2-(2-ethoxyethoxy)-1,1,1-trifluoroethane (F3); 1,2-bis(2,2-difluoroethoxy)ethane (F4); 2-(2-(2,2-difluoroethoxy)ethoxy)-1,1,1-trifluoroethane (F5), and 1,2-bis(2,2,2-trifluoroethoxy)ethane (F6).

12. The liquid electrolyte of claim 10, wherein the tertiary partially fluorinated ether is 1,2-bis(2,2-difluoroethoxy)ethane (F4) or 2-(2-(2,2-difluoroethoxy)ethoxy)-1,1,1-trifluoroethane (F5).

13. The liquid electrolyte of claim 10, wherein the steric-ether solvent is 1,2-diethoxyethane (DEE).

14. The liquid electrolyte of claim 13, wherein a volumetric ratio of the steric-ether solvent to the diluent is between 1:3 and 1:1.

15. The liquid electrolyte of claim 13, wherein a volumetric ratio of the steric-ether solvent to the tertiary partially fluorinated ether is between 1:2 and 2:1.

16. The liquid electrolyte of claim 10, wherein the liquid electrolyte consists essentially of:
lithium bis(fluorosulfonyl)imide (LiFSI), operable as the lithium-containing salt,
1,2-diethoxyethane (DEE), operable as the steric-ether solvent, and
1,1,2,2-tetrafluoroethyl 2,2,3,3-tetrafluoropropylether (TTE) operable as the diluent, and
1,2-diethoxyethane (DEE), operable as the steric-ether solvent.

17. The liquid electrolyte of claim 1, wherein the liquid electrolyte further comprises an additive selected from the group consisting of ethylene carbonate (EC), propylene carbonate (PC), dimethyl carbonate (DMC), diethyl carbonate (DEC), ethyl methyl carbonate (EMC), vinyl carbonate (VC), vinyl ethylene carbonate (VEC), fluoroethylene carbonate (FEC), difluoroethylene carbonate (DFEC), 3,3,3-trifluoropropylene carbonate (TFPC), 1,2-dimethyoxylethane (DME), 1,3-dioxolane (DOL), 1,4-dioxane (DOX), tetrahydrofuran (THF), acetonitrile (AN), ethyl acetate (EA), methyl acetate (MA), methyl propanoate (MP), ethyl propanoate (EP), propyl propanoate (PP), N,N-Dimethylformamide (DMF), gamma-butyrolactone (BL), succinic anhydride (SA), butyric anhydride (BA), tetravinyl silane (TVSI), succinonitrile (SN), adiponitrile (ADN), 1,3,6-Hexanetricarbonitrile (HTCN), trimethyl borate (TMB), triphenyl borate (TPB), triethyl borate (TEB), tris(pentafluorophenyl)borane (TPFPB), tris(trimethylsilyl)phosphate (TTSB), tris(2,2,2-trifluoroethyl) borate (TTFEB), trimethyl phosphate (TMP), triethyl phosphate (TEP), tris(trimethylsilyl)phosphate (TTSP), tris(trimethylsilyl)phosphite (TTSPi), tris(2,2,2-trifluoroethyl) phosphate (TFEPa), tris(2,2,2-trifluoroethyl) phosphite (TFEPi), (pentafluorophenyl)diphenyl phosphine (PFPDPP), tris(pentafluorophenyl) phosphine (TPFPP), ethoxy(pentafluoro)cyclotriphosphazene (PFPN), 1,3,2-dioxathiolane-2,2-dioxide (DTD), 1,3-propanesultone (PS), prop-1-ene-1,3-sultone (PES), propanediol cyclic sulfate (PCS), ethylene sulfite (ES), 1,4-butane sultone (BS), diphenyl sulfone (DPS), dimethyl sulfoxide (DMSO), 1,2,6-oxadithiane-2,2,6,6-tetraoxide (ODTO), methylene methanedisulfonate (MMDS), lithium bis(trifluoromethanesulfonyl)imide (LiTFSI), lithium bis(pentafluoroethanesulfonyl)imide (LiBETI), lithium hexafluorophosphate (LiPF₆), lithium hexafluoroarsenate (LiAsF6), lithium tetrafluoroborate (LiBF₄), lithium bis(oxalato)borate (LiBOB), lithium difluoro(oxalato)borate (LiDFOB), lithium difluorophosphate (LiDFP), lithium difluoro(dioxalato)phosphate (LiDFDOP), lithium tetrafluoro(oxalato)phosphate (LiTFOP), lithium nitrate (LiNO₃), lithium perchlorate (LiClO4), lithium triflate (LiTf), lithium trifluoroacetate (LiTFA), lithium 4,5-dicyano-2-(trifluoromethyl)imidazole (LiTDI), sodium hexafluorophosphate (NaPF6), sodium bis(fluorosulfonyl)imide (NaFSI), sodium bis(trifluoromethanesulfonyl)imide (NaTFSI), sodium triflate (NaTf), sodium bis(pentafluoroethanesulfonyl)imide (NaBETI), potassium hexafluorophosphate (KPF₆), potassium bis(fluorosulfonyl)imide (KFSI), potassium bis(trifluoromethanesulfonyl)imide (KTFSI), potassium triflate (KTf), cesium bis(fluorosulfonyl)imide (CsFSI), cesium bis(trifluoromethanesulfonyl)imide (CsTFSI), magnesium bis(trifluoromethanesulfonyl)imide (Mg(TFSI)₂), zinc bis(trifluoromethanesulfonyl)imide (Zn(TFSI)₂), calcium bis(trifluoromethanesulfonyl)imide (Ca(TFSI)₂), silver bis(trifluoromethanesulfonyl)imide (AgTFSI), aluminum bis(trifluoromethanesulfonyl)imide (AI(TFSI)3), and lanthanum bis(trifluoromethanesulfonyl)imide (La(TFSI)₃).

18. The liquid electrolyte of claim 17, wherein the additive is selected from the group consisting of diphenyl sulfone (DPS), lithium difluoro(oxalato)borate (DFOB), lithium difluorophosphate (DFP), lithium bis(oxalato)borate (BOB), and lithium tetrafluoroborate (BF₄).

19. The liquid electrolyte of claim 17, wherein the additive has a concentration of 0.1-5% by volume.

20. The liquid electrolyte of claim 17, wherein the additive has a concentration of 0.01-0.5M.
